(19) United States
(12) Patent Application Publication
(10) Pub. No.: US 2016/0367953 A1
(43) Pub. Date: Dec. 22, 2016

(54) SPINNING DEVICE

(71) Applicant: Rachel First, Las Vegas, NV (US)

(72) Inventor: Rachel First, Las Vegas, NV (US)

(21) Appl. No.: 14/744,791

(22) Filed: Jun. 19, 2015

(51) Int. Cl. B01F 9/00

(52) U.S. Cl. CPC B01F 9/003

(57) ABSTRACT

A spinning device automates the spinning of a composition, such as insulin, in a container. The device creates a slow, uniform spinning motion while securely retaining the container. This helps eliminate the conditions of dropping the container, or excessive agitations to the composition that create air bubble. A bifurcated housing includes a motor region having a motor, and a spin region having a clasp portion. A shaft connects the motor to the clasp portion thus spinning the clasp portion. The spin region is covered by a transparent observation door. The motor region includes a control portion with a power switch, a light emitting diode, and a digital display with a power-indicating light. The clasp portion is C-shaped and spring biased inwardly to secure the container. An inner grip layer overlays the clasp portion to inhibit slippage. A spin regulator maintains the container in an upright position.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### FIELD OF THE INVENTION

One or more embodiments of the invention generally relate to a spinning device that automates controlled spinning of a composition. More particularly, the invention relates to a spinning device that automates controlled spinning of a composition that is susceptible to air bubble formation, such as insulin, through the utilization of a clasp portion that securely retains a container of the composition, and a regulated motor that operatively connects to the clasp portion for controlled spinning, while also enabling visible verification of the composition during spinning.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that people with diabetes need to keep their blood glucose level in the normal range by regularly monitoring it and injecting insulin based on the measured blood glucose level. This requires routine blood glucose measurements. Using a blood tester, the patient pierces the skin (e.g., on the finger tip) to draw blood, allowing a small quantity of blood to be sampled into the device for the analysis of glucose or other blood components.

Typically, insulin is a peptide hormone produced by beta cells in the pancreas. It regulates the metabolism of carbohydrates and fats by promoting the absorption of glucose from the blood to skeletal muscles and fat tissue and by causing fat to be stored rather than used for energy. Insulin also inhibits the production of glucose by the liver.

In many instances, medicinal insulin is used to treat a number of disease including diabetes. The insulin must be prepared by gently rolling the container back and forth within the hands, and then administered insulin is usually taken as subcutaneous injection by single-use syringes with needles, an insulin pump, or by repeated-use insulin pens with needles.

Preparation of the insulin requires rolling the bottle gently between the hands for 5 to 10 seconds and then tumbling it top over bottom for at least 10 rotations to mix it thoroughly. However, it is better not to shake the bottle, or the insulin will become frothy and difficult to measure.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a perspective view of an exemplary housing, facing an exemplary spin region, in accordance with an embodiment of the present invention;

FIG. 2 illustrates a perspective view of an exemplary housing, facing an exemplary motor region, in accordance with an embodiment of the present invention;

FIG. 3 illustrates a perspective view of an exemplary spin region with an exemplary transparent door open, in accordance with an embodiment of the present invention;

FIG. 4 illustrates a perspective view of an exemplary control portion having an exemplary power switch, an exemplary power-indicating light, an exemplary light emitting diode, and an exemplary digital display screen, in accordance with an embodiment of the present invention;

FIG. 5 illustrates a perspective view of an exemplary clasp portion, in accordance with an embodiment of the present invention;

FIG. 6 illustrates a perspective view of an exemplary clasp portion with an exemplary spring that is biasing an exemplary body portion inwardly against an exemplary container, in accordance with an embodiment of the present invention;

FIG. 7 illustrates a perspective view of an exemplary clasp portion retaining an exemplary container in an upright position, in accordance with an embodiment of the present invention; and

FIG. 8 illustrates a perspective view of an exemplary clasp portion spinning an exemplary container, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys. Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of or interaction with, some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of.”

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

There are various types of devices that are configured to spin a container containing a composition that may be provided by preferred embodiments of the present invention. In one embodiment of the present invention, a spinning device is configured to controllably automate the spinning of a composition that is contained in a container. The device is configured to create a slow, uniform spinning motion while securely retaining the container of composition. This helps eliminate the conditions of dropping the container, or excessive oscillations and agitations to the composition that may occur when shaking by hand. Those skilled in the art will recognize that some compositions are susceptible to formation of air bubbles when agitated in a fast, irregular pattern. The air bubbles may be undesirable, such as for an insulin composition that is susceptible to air bubble formation.

In some embodiments, the device may include a bifurcated housing. A barrier separates a motor region from a spin region of the housing. The motor region of the housing may contain a motor, a sectional length of a shaft, a power portion, and circuitry for powering of the device. A sealed compartment protects the components in the motor region. A control portion operatively connects to, and positions on the sealed compartment. The control portion may include power switch configured for powering on and off the device, a light emitting diode that illuminates when the device is powered on, and a digital display screen for indicating the power-indicating light of a power portion.

The spin region of the housing may include a clasp portion for secure retention of the container, and a sectional length of the shaft. An at least partially transparent observation door may hingedly cover the clasp portion. The observation door may enable visible verification of the container of composition, such as insulin, during spinning. In some embodiments, a lid may hingedly cover the housing from a top end.

In some embodiments, the spin region of the housing may include a clasp portion that securely retains a container of the composition. In some embodiments, the clasp portion may securely retain the container through a spring biased inward pressure and an inner grip layer. Those skilled in the art will recognize that the container may include a thin glass bottle that is susceptible to breakage. Thus, the clasp portion helps inhibit dropping of the container with a generally circular body portion that is configured to snugly enclose around the container while creating a spring biased inward pressure with a spring at the end of the body portion. In some embodiments, the body portion may be generally C-shaped and terminates in a pair of terminal flares that help guide the container into the body portion. The inner grip layer overlays the inside of the body portion, creating frictional engagement with the container to inhibit slippage.

In some embodiments, the motor region of the housing may include a regulated motor that operatively connects to the clasp portion through a shaft for controlled spinning. The motor may include an electrical motor that generates power for spinning the clasp portion. The shaft attaches to the motor from a motor end. The shaft attaches to the clasp portion from a clasp end. A power portion, such as a battery provides power to the motor portion. The power portion may include a charging port to enable recharging form an external power source.

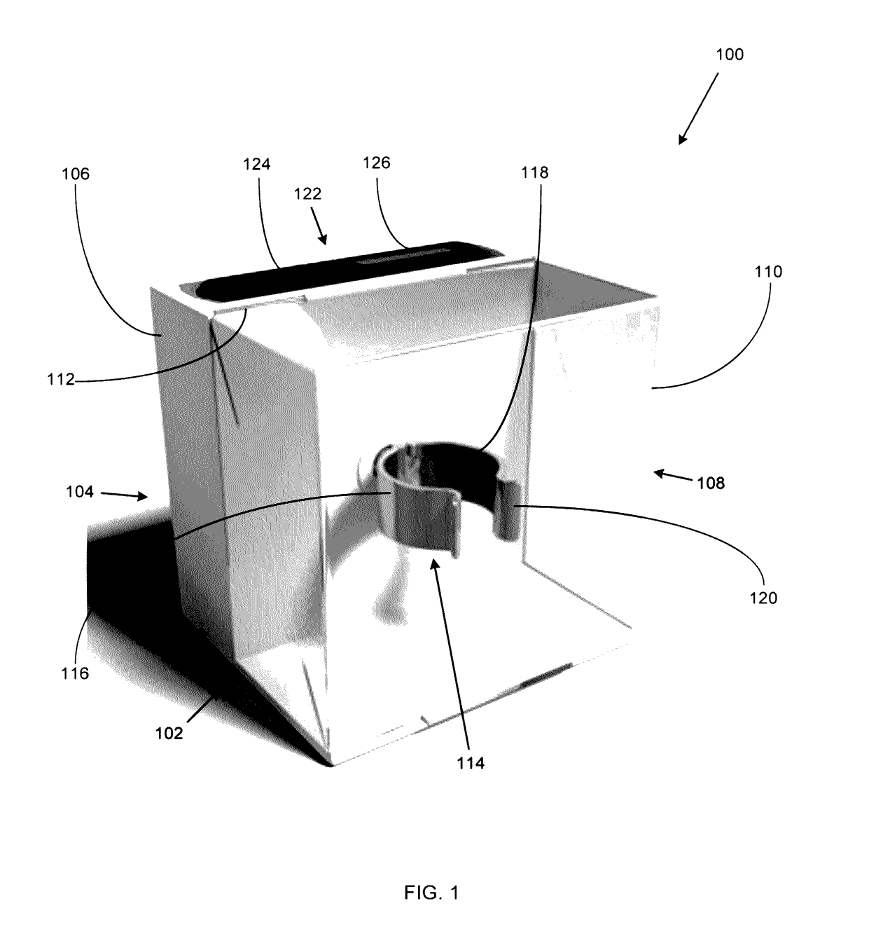

FIG. 1 illustrates a perspective view of an exemplary housing, facing an exemplary spin region, in accordance with an embodiment of the present invention. In one aspect of the invention, a spinning device 100 is configured to controllably automate the spinning of a composition that is contained in a container. The container may include, without limitation, a glass bottle, a jar, and a vile. In some embodiments, the container may include insulin vial sizes of three milliliters (3 ml), ten milliliters (10 ml), and other sizes. The container may also be made in formats that accommodate vials of multiple sizes and capacities.

The composition may include, without limitation, insulin, medication, and a liquid where it is undesirable to have air bubbles. Thus, due to the composition of the liquid, i.e., insulin, the device is configured to create a slow, uniform spinning motion while securely retaining the container of composition. This helps eliminate the conditions of dropping the container, or excessive oscillations and agitations to the composition that may occur when spinning by hand.

Those skilled in the art will recognize that some compositions are susceptible to formation of air bubbles when agitated in a fast, irregular pattern. The air bubbles may be undesirable, such as for an insulin composition that is susceptible to air bubble formation. For example, without limitation, a diabetic or the caretaker of a diabetic may roll, and tumble the container of insulin to provide the necessary mixing.

During this preparation/mixing process it is possible to drop the insulin bottle. If the bottle breaks then a new bottle must be obtained at the pharmacy. This is expensive and time consuming, and the diabetic may not be able to take their insulin shot as planned because the insulin bottle broke. Even if the bottle doesn't break the jarring effect of the drop can cause air bubbles to form in the insulin, consequently resulting in the diabetic delaying the shot while waiting for the bubbles to dissipate.

In some embodiments, the device may include a bifurcated housing 102. The bifurcated housing may include a motor region 104, a spin region 108, and a barrier. In some embodiments, the housing may be sealed and safe for use within cool environments like refrigerators. The bifurcated housing may have a generally square shape. In one embodiment, the bifurcated housing is about 2.5 inches tall, 2.5 inches wide, and 2.5 inches in depth. Suitable materials for the housing may include, without limitation, high-density polyethylene, acrylonitrile butadiene styrene, polyvinyl chloride, polyethylene, stainless steel, aluminum, and aluminum alloy.

In one embodiment, the housing is sufficiently small, such that it may be removed from a refrigerator, put it in a coat pocket or slacks pocket, taken to work, and then put it in the refrigerator at work. The device may be small enough to fit into a pocket, a briefcase, purse, and a backpack for added portability. In one alternative embodiment, the housing may include multiple spin regions.

In some embodiments, the barrier may separate the motor region from the spin region of the housing. The motor region may be dimensioned generally smaller than the spin region. The motor region of the housing may contain a motor, a sectional length of a shaft (not shown), a power portion, and circuitry for powering of the device. A sealed compartment 106 protects the components in the motor region. The spin region of the housing may include a clasp portion for secure retention of the container, and a sectional length of the shaft.

In some embodiments, an at least partially transparent observation door 110 may hingedly cover the clasp portion. The observation door may enable visible verification of the container of composition during spinning Those skilled in the art will recognize that the transparent composition of the observation door enables visibility into the spin region of the housing. The container may thus be viewed while spinning, which is not only appealing but also confirms that the device is operational. Additionally, the observation door allows the user to see when the insulin is finished spinning after the device is powered off.

In some embodiments, a control portion may operatively connects to, and position on a top plane of the sealed compartment. The control portion may include power switch configured for powering on and off the device, a light emitting diode that illuminates when the device is powered on, and a digital display screen for indicating the power status of a power portion. The control portion is built into the top plane of the sealed compartment. The control portion does not touch the observation door. The control portion may include a power switch configured for powering on and off the device, a light emitting diode 112 that illuminates when the device is powered on, and a digital display screen with a power-indicating light for indicating the power status of a power portion.

In some embodiments, the spin region of the housing may include a clasp portion 114 that securely retains a container of the composition. In some embodiments, the clasp portion may securely retain the container through a spring biased inward pressure and an inner grip layer. Those skilled in the art will recognize that the container may include a thin glass bottle that is susceptible to breakage. Thus, the clasp portion helps inhibit dropping of the container with a generally circular body portion 116 that is configured to snugly enclose around the container while creating a spring biased inward pressure with a spring at the end of the body portion.

In some embodiments, the body portion may be generally C-shaped and terminates in a pair of terminal flares 120 that help guide the container into the body portion. An inner grip layer 118 overlays the inside of the body portion to create a frictional engagement with the container, and thereby inhibit slippage. In some embodiments, the top plane of the motor compartment may include a control portion 122 that regulates power with a power switch 124, and monitors the power supply with a digital display that indicates the power-indicating light 126, and illuminates the light emitting diode when then device is powered on. Other shapes for the clasp portion may include, without limitation, round, oval, square, and rectangular.

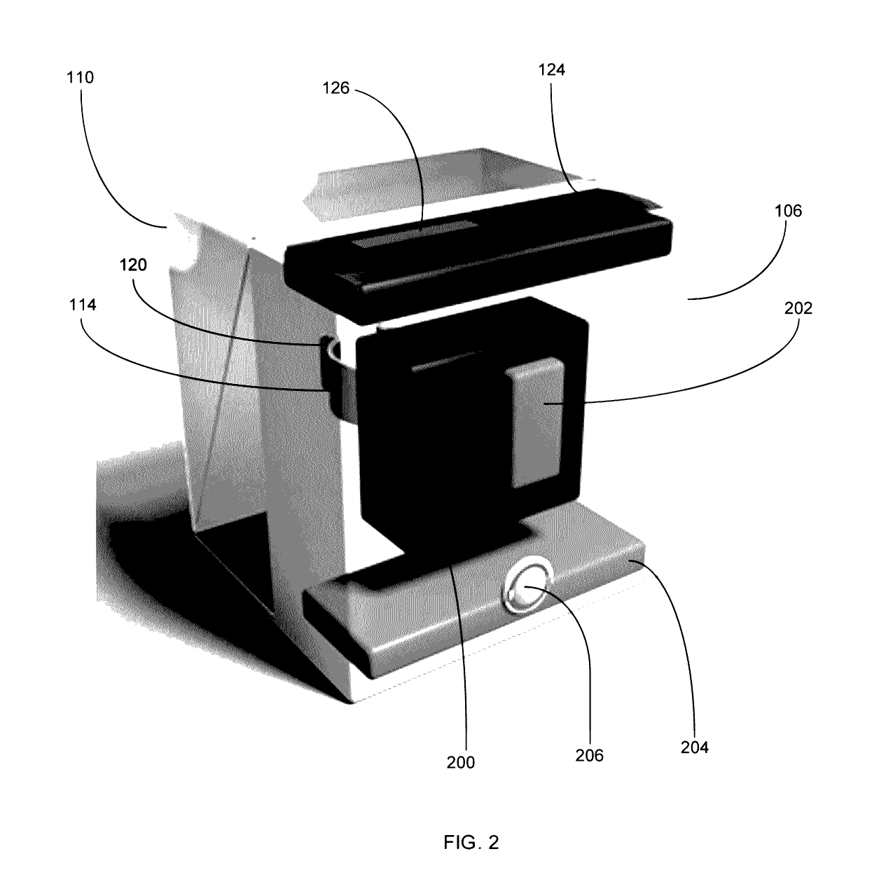

FIG. 2 illustrates a perspective view of an exemplary housing, facing an exemplary motor region, in accordance with an embodiment of the present invention. In one aspect of the invention, the motor region of the housing may include a regulated motor 200 that operatively connects to the clasp portion through a shaft for controlled spinning. The motor may include an electrical motor that generates power for spinning the clasp portion. The motor may be configured to be operable with an alternating current power source or a direct current power source. In some embodiments, the shaft may attach to the motor from a motor end (not shown). The shaft may also attach to the clasp portion from a clasp end. The motor rotates the shaft in a generally slow, uniform velocity, such that air bubbles do not form in the composition, i.e., insulin.

In some embodiments, a spin regulator 202 may operatively connect to the motor. The spin regulator is configured to at least partially control the motor by regulating the orientation of the clasp portion before and after the spinning motion commences. In this manner, the container is in an upright position when not spinning A counter weight may be used for this function.

A power portion 204, such as a battery may provide power to the motor portion. In one embodiment, the power portion is a rechargeable battery. The power portion may include a charging port 206 to enable recharging form an external power source. The charging port may be adapted to receive a power cord from an external power source. In one embodiment, a cap may cover the charging port. In one possible embodiment, an alert may sound or illuminate when the rechargeable battery is low. In one alternative embodiment, a timer may be set in the control portion to regulate the amount of spinning for the insulin. In one embodiment, the power source may include a battery that can be recharged by A/C and solar power.

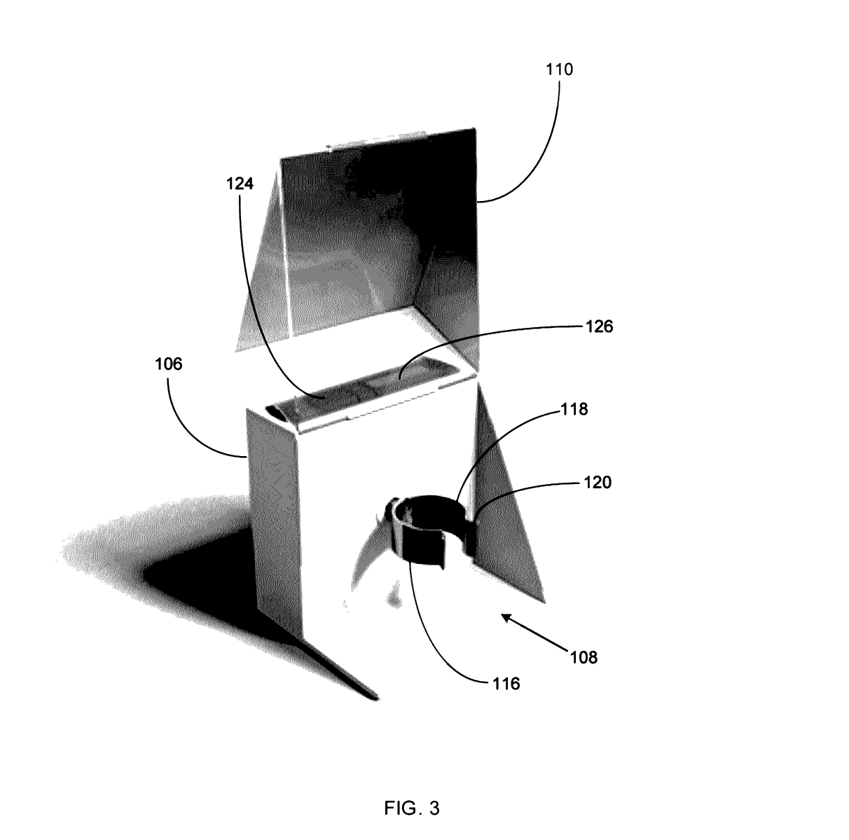

FIG. 3 illustrates a perspective view of an exemplary spin region with an exemplary transparent door open, in accordance with an embodiment of the present invention. In one aspect of the invention, the observation door enables viewing of the container while it is spinning. The observation door may have a generally triangular shape. Suitable materials for the observation door may include, without limitation, clear plastic, high-density polyethylene, acrylonitrile butadiene styrene, polyvinyl chloride, and polyethylene.

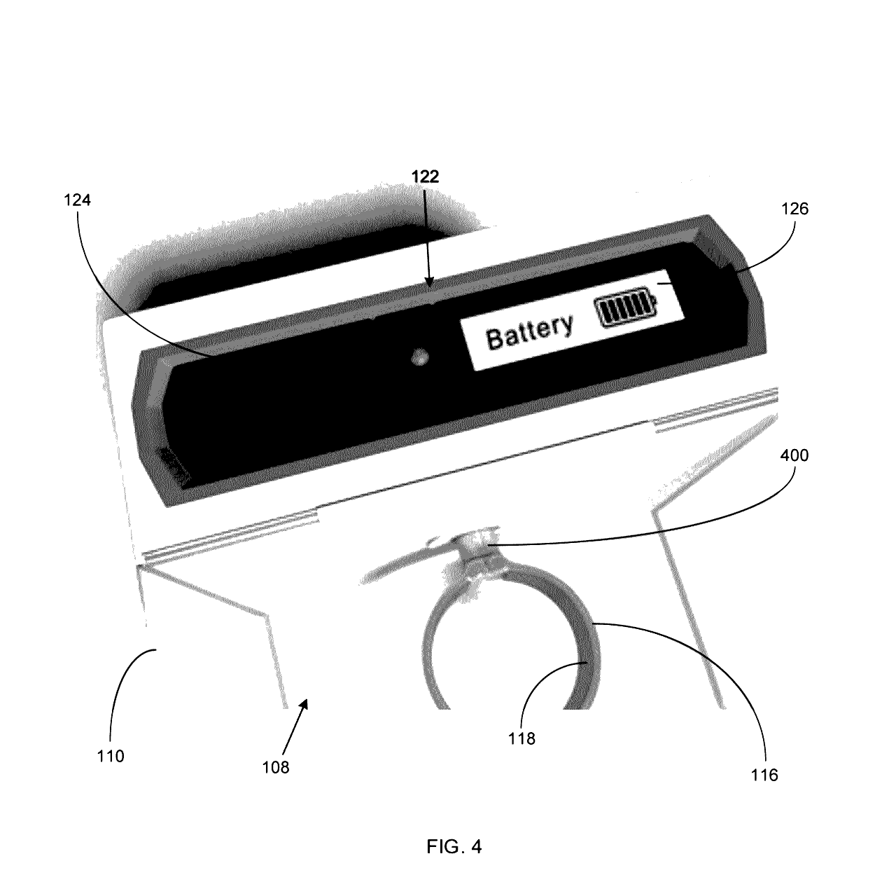

FIG. 4 illustrates a perspective view of an exemplary control portion having an exemplary power switch, an exemplary power-indicating light, and an exemplary power-indicating light, in accordance with an embodiment of the present invention. In one aspect of the invention, a control portion operatively connects to, and positions in an accessible part of the top end of the sealed compartment. The control portion may include power switch configured for powering on and off the motor, a light emitting diode that illuminates when the device is powered on, and a digital display screen for indicating the power-indicating light of a power portion. In one embodiment, the motor generates sufficient torque, such that the shaft spins. The clasp end 400 of the shaft, which connects to the clasp portion, may then transmit the torque to the container for the slow, uniform velocity spinning.

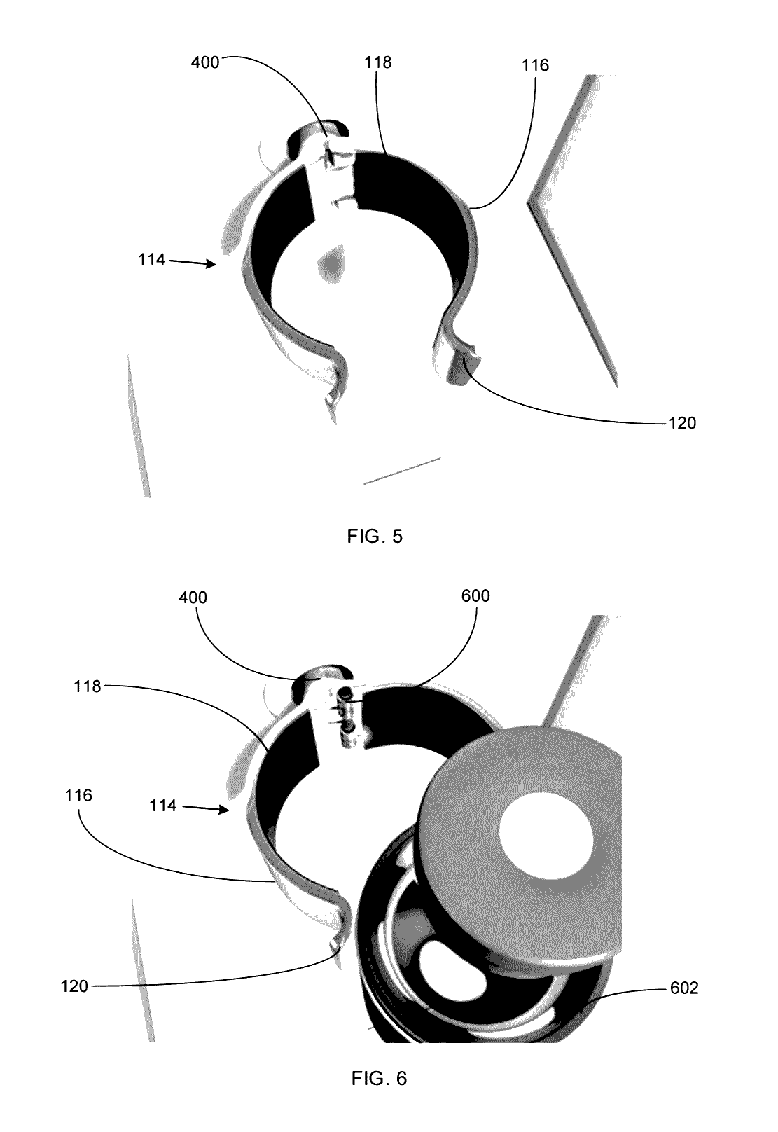

FIG. 5 illustrates a perspective view of an exemplary clasp portion, in accordance with an embodiment of the present invention. In one aspect of the invention, the clasp portion comprises a body portion that is sized and dimensioned to receive the container. In one embodiment, the body portion is generally C-shaped to conform to the shape of a bottle of insulin. The inner grip layer, which may include textured rubber also works to inhibit slippage between the container and the body portion. Additionally, the pair of terminal flares are outwardly disposed to catch and funnel the container into the body portion. The terminal flares may not have the inner grip layer, so as to facilitate passage therein. In one embodiment, the device may have two separate clasp portions. One may be rigid, and the second clasp portion may be spring biased.

FIG. 6 illustrates a perspective view of an exemplary clasp portion with an exemplary spring that is biasing an exemplary body portion inwardly against an exemplary container, in accordance with an embodiment of the present invention. In one aspect of the invention, the body portion may meet the clasp end of the shaft at a spring 600. The spring biases the body portion inwardly, so as to form a snug fit with the container 602. Those skilled in the art will recognize that the shape and dimensions of an insulin bottle are configured for single usage, and therefore have a consistent size.

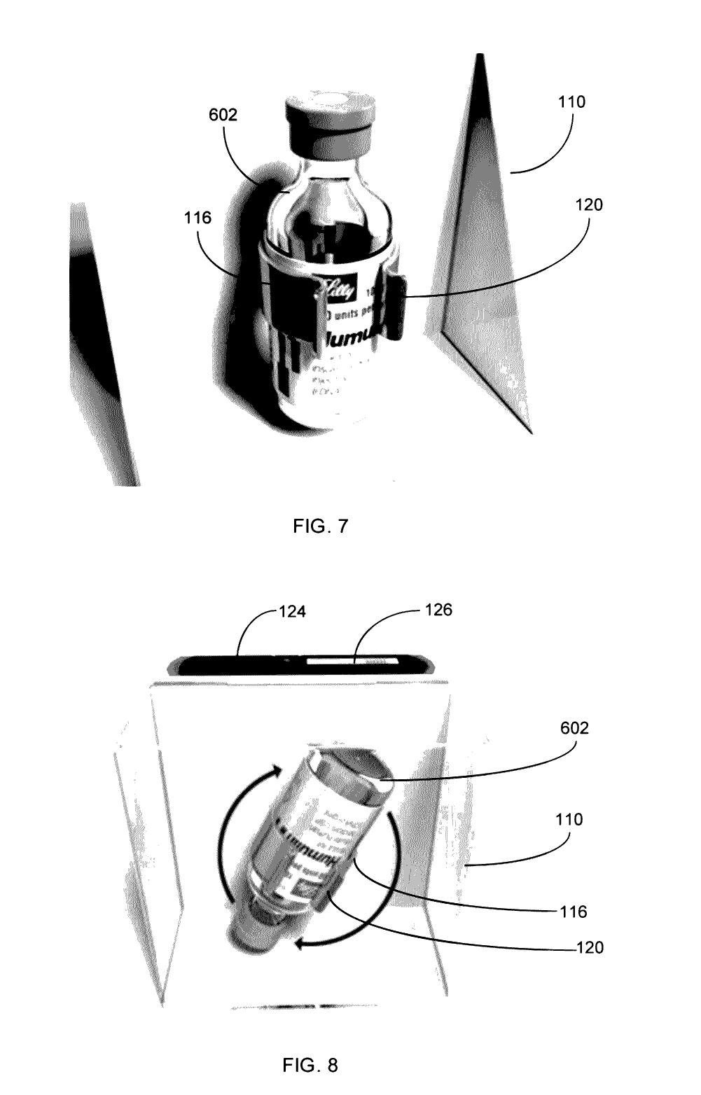

FIG. 7 illustrates a perspective view of an exemplary clasp portion retaining an exemplary container in an upright position, in accordance with an embodiment of the present invention. In one aspect of the invention, a spin regulator may operatively connects to the motor. The spin regulator is configured to at least partially control the motor by regulating the orientation of the clasp portion before and after the spinning motion commences. In FIG. 7, the spin regulator maintains the container in an upright position to inhibit the formation of air bubbles.

FIG. 8 illustrates a perspective view of an exemplary clasp portion spinning an exemplary container, in accordance with an embodiment of the present invention. In one aspect of the invention, the shaft may rotate, such that the attached container spins in a generally slow, uniform velocity. The device does not create irregular motions or drop the container, as may be the case when mixing the composition by hand. In one embodiment, the device can spin the container very slowly, such as, but not limited to 20 rotations per minute.

In one alternative embodiment, the shaft moves in an in-and-out direction to complement the spinning movement. In another alternative embodiment, the clasp portion has a screw that tightens down on the container, rather than a spring that biases the body portion inwardly. In another alternative embodiment, the housing has a second spin region for spinning a second container of insulin.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a spinning device that automates controlled spinning of a composition according to the present invention will be apparent to those skilled in the art. Various aspects of the invention have been described above by way of illustration, and the specific embodiments disclosed are not intended to limit the invention to the particular forms disclosed. The particular implementation of the spinning device that automates controlled spinning of a composition may vary depending upon the particular context or application. By way of example, and not limitation, the spinning device that automates controlled spinning of a composition described in the foregoing were principally directed to a device that securely retains a bottle of insulin for automated spinning in a slow, uniform manner implementations; however, similar techniques may instead be applied to spinning of a variety of liquids that are susceptible to formation of air bubbles, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A device comprising:
a housing, said housing comprising a motor region, a spin region, and a barrier, said motor region comprising a sealed compartment, said spin region comprising an at least partially transparent observation door, said barrier being configured to at least partially segregate said motor region from said spin region;
a shaft, said shaft comprising a motor end and a clasp end;
a motor, said motor being disposed in said motor region, said motor being configured to join with said motor end of said shaft, said motor being configured to spin said shaft in a generally slow, uniform velocity;
a clasp portion, said clasp portion being disposed in said spin region, said clasp being configured to join with said clasp end of said shaft, said clasp portion comprising a body portion, said body portion comprising a spring, said spring being configured to at least partially bias said body portion inwardly, said body portion further comprising an inner grip layer;
a spin regulator, said spin regulator being configured to at least partially control said motor, wherein said spin regulator helps regulate the orientation of said clasp portion before and after said spinning motion commences; and
a control portion, said control portion comprising a power switch and a power-indicating light.

2. The device of claim 1, wherein said housing is generally square shaped.

3. The device of claim 2, wherein said housing is about 2.5 inches tall, 2.5 inches wide, and 2.5 inches in depth.

4. The device of claim 3, in which said housing comprises at least one member selected from the group consisting of: high-density polyethylene, acrylonitrile butadiene styrene, polyvinyl chloride, polyethylene, stainless steel, aluminum, and aluminum alloy.

5. The device of claim 4, wherein said motor region is configured to have generally smaller dimensions than said spin region of said housing.

6. The device of claim 5, wherein said control portion is disposed to position on a top plane of said sealed compartment.

7. The device of claim 1, wherein said power switch comprises an off position and an on position.

8. The device of claim 7, wherein said power-indicating light is configured to display on a digital display screen.

9. The device of claim 8, in which said control portion further comprises a light emitting diode.

10. The device of claim 9, wherein said motor is configured to be operable with an alternating current power source or a direct current power source.

11. The device of claim 10, in which said body portion of said clasp portion comprises a substantially C-shape.

12. The device of claim 11, in which said body portion comprises a pair of terminal flares.

13. The device of claim 12, wherein said clasp portion is configured to enable reception of a container.

14. The device of claim 13, in which said container comprises a bottle of insulin.

15. The device of claim 14, in which said inner grip layer comprises a rubber texture.

16. The device of claim 15, in which said device comprises a power portion.

17. The device of claim 16, in which said power portion comprises a rechargeable battery.

18. The device of claim 17, in which said power portion comprises a charging port.

19. A device comprising:
means for securely retaining;
means for spinning;
means for controllably spinning said retaining means;
means for regulating said spinning means, wherein said spinning means comprises a uniform, slow spinning motion;
means for viewing said retaining means while spinning;
means for powering said spinning means; and
means for monitoring said powering means.

20. A device consisting of:
a housing, said housing comprising a motor region, a spin region, and a barrier, said motor region being generally smaller than said spin region, said motor region comprising a sealed compartment, said spin region comprising an at least partially transparent observation door, said barrier being configured to at least partially segregate said motor region from said spin region, said housing further comprising a generally square shape;
a motor, said motor being disposed in said motor region, said motor being configured to join with said motor end of said shaft, said motor being configured to spin said shaft in a generally slow, uniform velocity;
a clasp portion, said clasp portion being disposed in said spin region, said clasp being configured to join with said clasp end of said shaft, said clasp portion comprising a body portion, said body portion comprising a substantially C-shape, said body portion further comprising a pair of terminal flares, said body portion further comprising a spring, said spring being configured to at least partially bias said body portion inwardly, said body portion further comprising an inner grip layer;
a spin regulator, said spin regulator being configured to at least partially control said motor, wherein said spin regulator helps regulate the orientation of said clasp portion before and after said spinning motion commences;
a control portion, said control portion comprising a power switch, a power-indicating light, and a light emitting diode; and
a power portion, said power portion configured to at least partially provide power to said motor, said power portion comprising a rechargeable battery, said rechargeable battery comprising a charging port.
